(19) United States
(12) Patent Application Publication
(10) Pub. No.: US 2026/0233309 A1
(43) Pub. Date: Aug. 13, 2026

(54) METHOD FOR ADDITIVE MANUFACTURING OF A METAL PART

(71) Applicant: SAFRAN ADDITIVE MANUFACTURING CAMPUS, LE HAILLAN (FR)

(72) Inventors: Aurèle Arthur Pierre GERMAIN, MOISSY-CRAMAYEL (FR); Timothée DELACROIX, MOISSY-CRAMAYEL (FR)

(21) Appl. No.: 19/155,637

(22) PCT Filed: Feb. 19, 2024
(86) PCT No.: PCT/FR2024/050215

§ 371 Date: Aug. 12, 2025

(30) Foreign Application Priority Data
Feb. 21, 2023 (FR) FR2301599

(51) Int. Cl. B22F 10/38; B22F 10/28; B22F 10/80; B33Y 10/00; B33Y 50/00

(52) U.S. Cl. CPC B22F 10/38; B22F 10/28; B22F 10/80; B33Y 10/00; B33Y 50/00; B22F 2998/10

(57) ABSTRACT

A method for additive manufacturing of a metal part, by selective sintering of at least one layer of a metal powder by means of a laser beam includes a determination step for determining a plurality of sets of parameters, a production step for producing at least one sample for each set of parameters by additive manufacturing, an analysis step for analyzing the sample to obtain a distribution of at least one dimension of the pores of the sample, an obtaining step for obtaining a manufacturing speed for the manufacture of the part using the set of parameters, a selection step for selection one of the sets of parameters based on the characteristic values for the distribution of the dimension of the pores and for the manufacturing speed associated with each set of parameters, and a step of additive manufacturing of the part using the selected set of parameters.

### TECHNICAL FIELD OF THE INVENTION

The invention relates to the field of additive manufacturing, in particular additive manufacturing by selective laser sintering on a powder bed, also known by the acronym “SLS” for “Selective Laser Sintering”.

More specifically, the invention relates to a method for manufacturing a mechanical part by additive manufacturing.

### PRIOR ART

A method is known for manufacturing at least one part, in particular one or more metal parts, by a selective sintering of successive layers of metal powder, using a laser beam controlled by a control and information processing system in which are stored the three-dimensional coordinates of the points of the successive layers to be produced to form the part.

A step of selective sintering of successive layers of powder involves a number of parameters that influence the final structure of the material and, thus, the mechanical properties of the manufactured part.

Such parameters include variables relating to the laser beam, such as beam radius and average power, relating to the path in the powder layer, such as path speed and distance between two neighboring scan lines, or relating to the granular material, such as grain size and thickness of successive powder layers.

Selecting a set of parameters for a selective sintering process is generally based on producing samples while using several sets of parameters, and measuring the density of the material via an optical analysis of a polished surface of each sample.

Porosities detected by image analysis are used to define the quality and strength of the material of the produced sample.

However, such a technique, while effective, does not provide sufficient discrimination between different sets of parameters that yield satisfactory results. Indeed, simply measuring the density of samples is insufficient for effectively predicting the final behavior of the part.

Visual comparison of images by an operator is also unacceptable, as it is rarely repeatable across different operators.

### PRESENTATION OF THE INVENTION

The invention aims to overcome such disadvantages by enabling the development of effective sets of parameters that optimize both the manufacturing speed of a part and a quality of the material.

To this end, the invention relates to a method for additive manufacturing of a metal part, by selective sintering of at least one layer of a metal powder by means of a laser beam controlled by a control system. More specifically, the method for additive manufacturing comprises at least:
a determination step, during which a plurality of sets of parameters are determined, in particular each set of parameters comprising at least a laser beam power, a scanning speed at which the laser beam scans each powder layer, a distance between two scanning lines of the laser beam on each layer, and/or a thickness of each layer,
a production step, during which at least one sample is produced, for each set of parameters, by additive manufacturing using such a set of parameters,
an analysis step, during which the sample is analyzed to obtain a distribution of at least one dimension of the pores of the sample,
an obtaining step, during which, for each set of parameters, a manufacturing speed is obtained for the manufacture of the part using the set of parameters,
a selection step, during which one of the sets of parameters is selected based on the characteristic values for the distribution of the dimension of the pores and for the manufacturing speed associated with each set of parameters, and
a step of additive manufacturing of the part using the selected set of parameters.

Such a method provides rapid and comprehensive access to information relating to the samples' porosity and thus allows selecting a set of parameters for manufacturing the part that offers the best compromise between a quality of the material and a manufacturing speed.

Advantageously, the set of parameters comprises the following four parameters:
a power of the laser beam,
a scanning speed at which the laser beam scans each powder layer,
a spacing between two scanning lines of the laser beam on each powder layer, and/or
a thickness of each powder layer.

It is reminded that a pore is an empty space within a solid material. Consequently, porosity is the ratio of the volume occupied by the pores to the total volume of the pores and of the solid material.

The analysis step may comprise a calculation step, during which at least one characteristic value of the distribution associated with the set of parameters used to produce the sample is calculated.

The analysis step may comprise acquiring a two-dimensional image of a surface of the sample and analyzing the image in order to identify at least one pore of the sample.

Such a feature allows identifying each pore of a representative surface of the sample, in order to quickly and reliably determine the distribution of the at least one dimension of the pores of the sample.

The dimension is, for example, a largest pore diameter, a smallest pore diameter, a pore surface area, and/or an indication of whether the pore is spherical or linear in character.

The image analysis is, for example, a grayscale analysis involving a threshold for discriminating between the pores and the solid material.

The pore dimension obtained in the analysis step may be a largest pore diameter or a smallest pore diameter.

Such a feature provides information on the linear or spherical nature of each of the observed pores, and thus characterizes the dominant type of porosity in the material. Different types of porosity are more or less critical for different intended roles of the part.

The terms “largest diameter” and “smallest diameter” of the pore are referred to as the Feret diameter, and substantially correspond to the respective diameters of a circle circumscribed around the pore and a circle inscribed in the pore.

The analysis step may also comprise a sorting step, during which the set of parameters, associated with the sample comprising at least one pore for which the largest diameter is greater than a limit value is eliminated.

Such a feature allows directly excluding the sets of parameters that result in porosities detrimental to the mechanical strength of the part. The limit value is, for example, 100 micrometers.

The presence of linear-type pores having such dimensions greatly limits the fatigue resistance of parts subjected to mechanical stress.

During the selection step, the characteristic values of each distribution of at least one dimension of the pores may include a minimum, a first quartile, a median, a third quartile, and/or a maximum of the distribution.

Such a feature makes it possible to characterize the distribution of the dimension of the pores by a small number of values that concentrate the information, in order to facilitate processing. The method for additive manufacturing may comprise a step of graphically representing the minimums, first quartiles, medians, third quartiles, and/or maximums associated with each set of parameters, in the form of box-and-whisker plots ordered according to the manufacturing speed using the associated set of parameters.

Such a feature simplifies the analysis by presenting the results obtained for the different samples in a clear manner, thus facilitating the selection of a set of parameters.

The selection step may comprise determining at least one condition relating to the distributions of the dimension of the pores, and selecting the set of parameters associated with the highest manufacturing speed and satisfying each of the conditions.

Such a feature simplifies the selection step and allows selecting a set of parameters enabling a high manufacturing speed.

The conditions may be chosen according to an intended role of the part and/or the mechanical and/or thermal stresses to which the part will be exposed.

Such a feature allows the criteria for selecting the set of parameters to be adapted to the intended role of the part, in order to obtain the set that allows for the best manufacturing speed. For example, a part intended to undergo repeated mechanical stresses will be more sensitive to a significant porosity, particularly a significant linear porosity, i.e. one having large values for the largest diameter. In comparison, a part subjected to little mechanical and/or thermal stress presents a lower risk of fatigue and can exhibit a higher and more linear porosity.

### BRIEF DESCRIPTION OF FIGURES

The invention will be better understood and other features and advantages will become further apparent upon reading the detailed description which follows, comprising embodiments given for illustrative purposes with reference to the appended figures, presented as non-limiting examples, which may serve to complete the understanding of the invention and the description of its implementation and, where appropriate, contribute to its definition, in which:

FIG. 1 is a schematic perspective view of a method for additive manufacturing by selective laser sintering on a metal powder bed according to the invention;

FIG. 2 is a detailed cross-sectional view of a pore of a part obtained by additive manufacturing;

FIG. 3 is a graphical representation of a distribution of a dimension of the pores in a sample obtained by additive manufacturing;

FIG. 4 is a graphical representation of characteristic values of the distribution of FIG. 3; and

FIG. 5 is a graphical representation of the characteristic values obtained for several samples during a selection step.

### DETAILED DESCRIPTION OF THE INVENTION

A method for additive manufacturing of a metal part by using a metal powder will be described. This type of method for additive manufacturing is useful for parts having complex three-dimensional geometries, for example heat exchangers, in particular for aeronautical applications.

The metal powder used in such a method for additive manufacturing is, for example, composed of an aluminum alloy, particularly the one designated AlSi7Mg0.6, comprising 7% by mass of silicon and 0.7% by mass of magnesium.

The method for additive manufacturing according to the invention comprises preliminary steps aimed at determining a set of parameters, for the additive manufacturing of the part, which allow reaching a good compromise between a quality and a strength of the material on the one hand and manufacturing speed on the other hand.

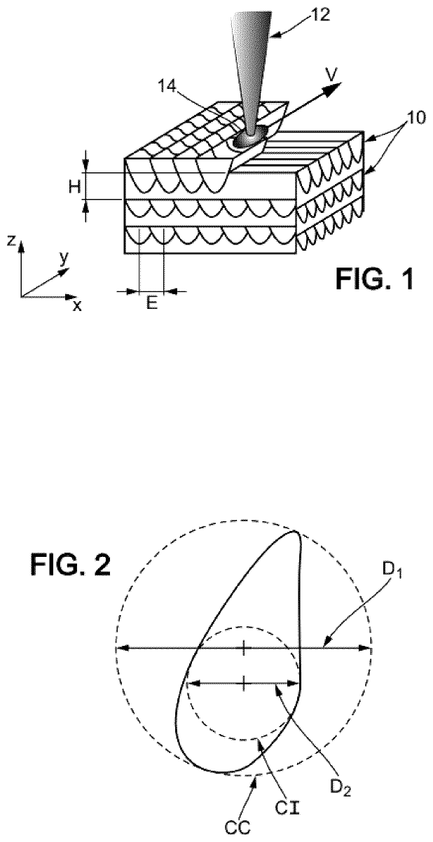

FIG. 1 is a schematic perspective view of a method for additive manufacturing using selective laser sintering on a metal powder bed according to the invention. More specifically, FIG. 1 illustrates a step in the additive manufacturing of the part, implemented by means of an additive manufacturing device, as well as the various parameters influencing the additive manufacturing step.

The additive manufacturing device comprises, in a known manner, a tank containing a metal powder that is deposited in at least one layer 10, in particular in successive layers 10, by means of a scraper. The layer 10 is substantially flat and extends in a substantially horizontal plane XY.

The successive layers 10 may be stacked in a heightwise direction Z.

The layer 10 has a thickness H controlled by a control system of the additive manufacturing device, controlled in particular by adjusting the movements of the tank from one layer 10 to the next.

The additive manufacturing device also comprises a laser source and optics (not shown), adapted to generate and control a laser beam 12 so as to form a movable point of incidence 14 on the layer 10.

The point of incidence 14 sweeps over a predetermined portion of the layer 10 in order to locally melt the layer 10 so as to add material to the manufactured part.

The power of the laser beam 12 is also controlled by a control system, to vary the melting depth of the powder. The power is, for example, an average power calculated on a transverse cross-section of the laser beam 12.

For each layer 10, the beam 12 scans the predetermined portion of the layer 10, in particular along lines parallel to a scanning direction, in particular spaced apart in the spacing direction. The scanning direction is, for example, parallel to a first transverse direction X and the spacing direction is, for example, parallel to a second transverse direction Y that is perpendicular to the first transverse direction X.

In the example shown, the scanning and spacing directions alternate in being parallel to the first and second transverse directions X, Y, from one layer 10 to the next.

The point of incidence 14 follows the path lines at a speed V, which determines the time taken by the beam to travel over the entire predetermined region of each layer 10.

The scanning lines are spaced apart in the spacing direction by a predetermined pitch E, also called the vector spacing, in particular chosen to be substantially equal to a width of the point of incidence 14 in the spacing direction.

A set of additive manufacturing parameters is defined by selecting values for the parameters mentioned above. Since most of these parameters are interdependent, selecting the values of the following four parameters allows creating a set of parameters that is sufficient for manufacturing the part, namely:
the power P of the laser beam,
the scanning speed V,
the vector spacing E, and
the thickness H of the layer 10.

Other combinations of parameters are conceivable for characterizing the additive manufacturing step and forming a set of parameters within the meaning of the invention.

The method for additive manufacturing comprises a step of determining a plurality of sets of parameters, capable of being tested in order to select the one among them that will be most suitable for manufacturing the mechanical part by additive manufacturing.

The sets of parameters may be determined based on known parameter values used in the previous manufacturing of similar parts, and selected in order to sweep through ranges of values to find an optimal combination.

The method for additive manufacturing then comprises a step of producing at least one sample, for each set of parameters, by additive manufacturing using such a set of parameters.

In particular, the sample has a simple geometry that allows for easy observation, for example a substantially parallelepiped geometry.

The dimensions of the sample are determined so as to present surfaces of sufficient size to be representative of the material during a statistical porosity analysis.

One of the surfaces of the sample is then polished to allow capturing at least one clear image of the surface, enabling image analysis.

The method for additive manufacturing then comprises a sample analysis step.

The sample analysis step may be performed using an optical method. In such a case, the optical method may comprise, for example, capturing a two-dimensional image of the sample surface, preferably the polished surface of the sample. Next, the sample analysis step may comprise using thresholding to analyze the obtained image in order to distinguish between a solid portion of the material and a porosity.

Other methods are possible, for example three-dimensional observation by X-ray tomography, allowing the entire volume of the sample to be recreated.

The sample analysis step allows identifying each of the pores on the sample surface and analyzing the pores' geometry.

The sample analysis step may also comprise obtaining a distribution of at least one dimension of the sample's pores.

An example is shown in FIG. 2, which is a detailed cross-sectional view of a pore 20 of the part obtained by additive manufacturing. The opening of the pore 20 is at the surface, particularly the polished surface, of the sample.

FIG. 2 shows two examples of characteristic dimensions of the pore 20:
a largest diameter D1, which is also a diameter of a circle CC circumscribed around the pore 20, considered for example in a plane of the image, and
a smallest diameter D2, which is also a diameter of a circle CI inscribed in the pore 20, considered for example in the plane of the image.

By convention, the pore 20 is considered to be
spherical in nature if the ratio D1/D2 is less than 2, and
linear in nature if the ratio D1/D2 is greater than or equal to 2.

The spherical or linear nature of the pore 20 may also serve as a pore dimension according to the invention.

The largest diameter D1 and the smallest diameter D2 are determined for each of the pores 20 of the two-dimensional image. A distribution of each of the largest diameters D1 and smallest diameters 2 is obtained for each analyzed sample.

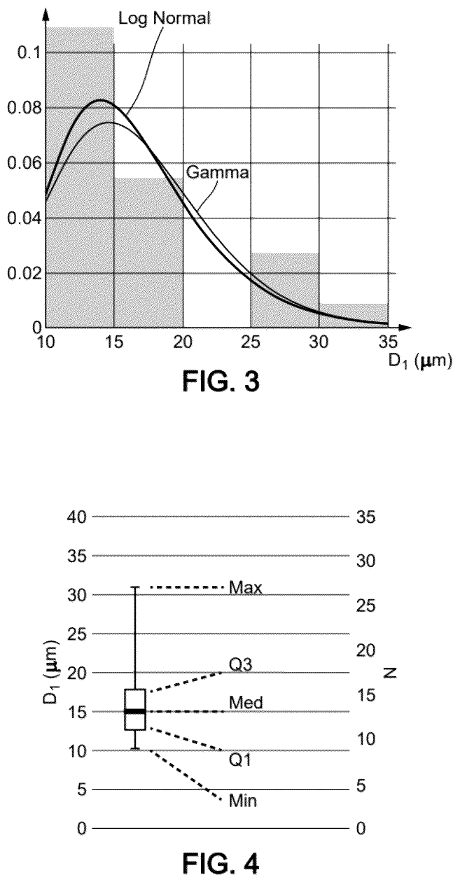

FIG. 3 is a graphical representation of the distribution of the largest pore diameter D1, in micrometers, obtained for such a sample obtained by additive manufacturing, represented both as a histogram and as LogNormal and Gamma distribution types of regression curves.

Such representations allow a large portion of the information to be preserved by rendering it visible, but do not facilitate the comparison of a large number of samples.

To remedy this, the analysis step may then comprise a step of calculating at least one characteristic value of the distribution associated with each set of parameters used to produce the analyzed samples.

As shown in FIG. 4 as a graphical representation of characteristic values of the distribution of FIG. 3, the characteristic values of the distribution include, for example, a minimum Min, a first quartile Q1, a median Med, a third quartile Q3, and a maximum Max of said distribution. The characteristic values are represented in the form of a box-and-whisker plot, or Tukey box-plot. Such a plot allows rapidly evaluating the different values and facilitates the comparison of multiple samples.

The plot is advantageously supplemented with additional information obtained through image analysis, for example such as the number N of distinct pores detected.

Advantageously, the method for additive manufacturing may comprise a sorting step, during which the sets of parameters associated with each sample comprising at least one pore for which the largest diameter D1 is greater than a limit value are eliminated. The limit value is, in particular, determined according to the intended role of the mechanical part and/or the mechanical and/or thermal stresses to which it will be exposed. For example, the limit value may be equal to 100 micrometers.

The method for additive manufacturing also comprises an obtaining step, during which, for each set of parameters, a manufacturing speed Vf of the part is obtained with such a set of parameters.

The manufacturing speed Vf of the part is determined by calculating a volume of material aggregated by the laser beam 12, as a function of the scanning speed V and the layer thickness H for such a set of parameters.

The method for additive manufacturing then comprises a step of selecting one of the sets of parameters Js based on the characteristic values and on the manufacturing speeds previously obtained for each set of parameters.

The selection may comprise, for example, a step of graphically representing the minimums, first quartiles, medians, third quartiles, and/or maximums associated with each set of parameters, in the form of box-and-whisker plots. The plots may be ordered according to the manufacturing speed using the associated set of parameters.

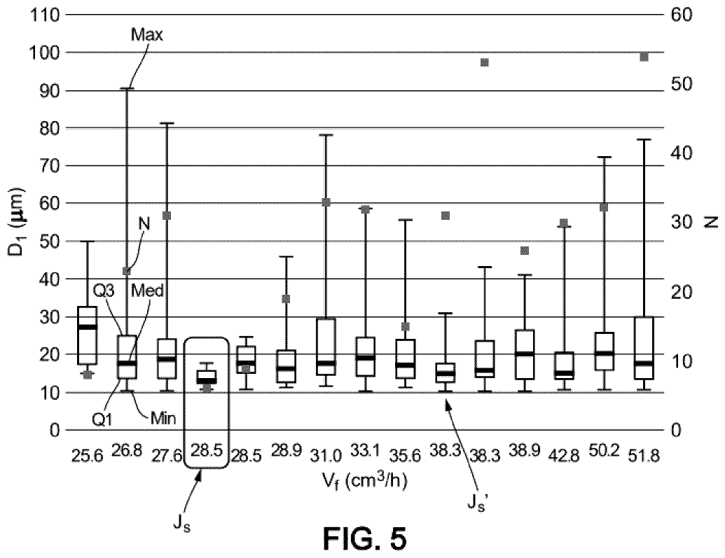

Such a graphical representation of the characteristic values obtained for several samples during a selection step is presented in FIG. 5. More specifically, FIG. 5 shows the characteristic values of the distributions of the largest pore 20 diameters D1, obtained for fifteen separate samples. The plots are arranged on the abscissa according to the manufacturing speed Vf, expressed in cubic centimeters per hour. The total number N of pores detected is also shown in this graph.

Such a graphical representation provides a good visualization of the tradeoff between the material quality and the associated manufacturing speed.

In the example shown in FIG. 5, for a part requiring good mechanical strength, the selected set of parameters Js is associated with a pore 20 distribution having the fewest largest diameters D1 and a highly non-linear character, which indicates good resistance to mechanical and thermal stresses.

The set of parameters Js comprises
a laser beam power P of 414 watts,
a vector spacing E of 0.08 millimeters,
a layer thickness H of 0.06 millimeters, and
a scanning speed V of 1.65 meters per second.

The associated production speed Vf is 28.5 cubic centimeters per hour.

If a lower mechanical strength is acceptable but production speed is important, another compromise may be chosen, for example with a second set of parameters Js′.

A third set of parameters could be determined using this method, providing an even better quality of the material than what is obtained with the second set of parameters Js′, but lower than what is obtained with the first set of parameters Js, for a manufacturing speed Vf equal to 54.4 cubic centimeters per hour.

The third set of parameters comprises
a laser beam power P equal to 440 Watts,
a vector spacing E equal to 0.12 millimeters,
a layer thickness H equal to 0.09 millimeters, and
a scanning speed V equal to 1.4 meters per second.

Alternatively, the selection step may comprise determining at least one condition relating to the distributions of the dimension of the pores and selecting the set of parameters associated with the highest manufacturing speed and satisfying each of the conditions.

Such conditions may, for example, be determined by mechanical and/or thermal tests.

The conditions are also chosen based on the part's intended role and/or the type of associated stresses.

For example, if the part is highly stressed mechanically and/or thermally, such as a heat exchanger, greater importance will be given to the quality and robustness of the material, while if the part is less stressed, such as an equipment housing, lower fatigue resistance will be considered.

Lastly, the method for additive manufacturing comprises a step of additive manufacturing of the part, using the selected set of parameters.

1. A method for additive manufacturing of a metal part, by selective sintering of at least one layer (10) of a metal powder by means of a laser beam (12) controlled by a control system, the method for additive manufacturing comprising:
a determination step, during which a plurality of sets of parameters are determined, in particular each set of parameters comprising:
a power (P) of the laser beam (12),
a scanning speed (V) at which the laser beam (12) scans the layer (10),
a distance (E) between two scanning lines of the laser beam (12) on each layer (10), and/or
a thickness (H) of each layer (10),
a production step, during which at least one sample is produced, for each set of parameters, by additive manufacturing using such a set of parameters,
an analysis step, during which the sample is analyzed to obtain a distribution of at least one dimension (D1, D2) of pores (20) of the sample,
an obtaining step, during which, for each set of parameters, a manufacturing speed (Vf) is obtained for the manufacture of the part using the set of parameters,
a selection step, during which one of the sets of parameters (Js) is selected based on the characteristic values for the distribution of the dimension (D1, D2) of the pores (20) and for the manufacturing speed (Vf) associated with each set of parameters, and
a step of additive manufacturing of the part using the selected set of parameters.

2. The method for additive manufacturing according to claim 1, wherein the analysis step comprises a calculation step during which at least one characteristic value of the distribution associated with the set of parameters used to produce the sample is calculated.

3. The method for additive manufacturing according to claim 1, wherein the analysis step comprises acquiring a two-dimensional image of a surface of the sample and analyzing the image in order to identify at least one pore (20) of the sample.

4. The method for additive manufacturing according to claim 1, wherein the dimension of the pores (20) that is obtained in the analysis step is a largest diameter (D1) of the pore (20) or a smallest diameter (D2) of the pore (20).

5. The method for additive manufacturing according to claim 4, wherein the analysis step comprises a sorting step, during which the set of parameters associated with the sample comprising at least one pore (20) for which the largest diameter (D1) is greater than a limit value is eliminated.

6. The method for additive manufacturing according to claim 1, wherein, during the selection step, the characteristic values of each distribution of the dimension of the pores (20) comprises a minimum (Min), a first quartile (Q1), a median (Med), a third quartile (Q3), and/or a maximum (Max) of the distribution.

7. The method for additive manufacturing according to claim 6, comprising a step of graphically representing the minimums (Min), first quartiles (Q1), medians (Med), third quartiles (Q3), and/or maximums (Max) associated with each set of parameters, in the form of box-and-whisker plots ordered according to the manufacturing speed (Vf) using the associated set of parameters.

8. The method for additive manufacturing according to claim 1, wherein the selection step comprises determining at least one condition relating to the distributions of the dimensions (D1, D2) of the pores (20) and selecting the set of parameters associated with the highest manufacturing speed (Vf) and satisfying each of the conditions.

9. The method for additive manufacturing according to claim 8, wherein the conditions are chosen according to an intended role of the part and/or the mechanical and/or thermal stresses to which the part will be exposed.
